(19) United States
(12) Patent Application Publication
(10) Pub. No.: US 2018/0177182 A1
(43) Pub. Date: Jun. 28, 2018

(54) EMULSIFIABLE CONCENTRATES COMPRISING TOPAMEZONE, BROMOXYNIL AND A SAFENER

(71) Applicant: BASF SE, Ludwigshafen (DE)

(72) Inventors: Klaus KOLB, Schifferstadt (DE); Katja MARXER, Maxdorf (DE); Gerd KRAEMER, Kerzenheim (DE); Johannes WEIMER, Raleigh, NC (US); Scott COLE, Apex, NC (US)

(21) Appl. No.: 15/128,624

(22) PCT Filed: Mar. 13, 2015
(86) PCT No.: PCT/EP2015/055268

§ 371 Date: Sep. 23, 2016

Related U.S. Application Data
(60) Provisional application No. 61/969,880, filed on Mar. 25, 2014.

(51) Int. Cl. A01N 25/04; A01N 43/80; A01N 37/34

(52) U.S. Cl. CPC A01N 25/04; A01N 37/34; A01N 43/80

(57) ABSTRACT

The present invention relates to emulsifiable concentrates (ECs) comprising topramezone, bromoxynil and at least one herbicide safener. The invention also relates to the process for preparation, use and methods of use of said concentrates.

The present invention relates to emulsifiable concentrates (ECs) comprising topramezone, bromoxinyl and a safener. The invention also relates to the process for preparation, use and methods of use of said concentrates.

In crop protection it is desirable to effectively control unwanted plants (weeds) vegetating along with useful plants (crop plants) and depriving them of natural resources. At the same time it is important that said products are tolerated by useful plants in question. With many highly effective herbicides there is a problem that their compatibility with useful plants, in particular dicotyledonous crop plants, such as cotton and oilseed rape, and graminaceous plants, such as barley, millet, corn, rice, wheat and sugar cane, is not always satisfactory, i.e. in addition to harmful plants, the crop plants, too, are damaged on a scale which cannot be tolerated. By reducing the application rates, useful plants are spared; however, naturally, the extent of control of harmful plants decreases, too.

Hence, a crop protection product shall have high efficacy, compatibility with crops and reliability of action. Also desirable is a broad spectrum of activity of such a product allowing the simultaneous control of multiple harmful plants. Therefore, it is always desirable to improve at least one or even more of the above characteristics of crop protection products.

Additionally, plant protection products shall exhibit good physical and chemical stability.

Topramezone (IUPAC: [3-(4,5-dihydro-1,2-oxazol-3-yl)-4-mesyl-o-tolyl](5-hydroxy-1-methylpyrazol-4-yl)methanone) as well as salts and esters thereof, is a well-known herbicide active compound (see C.D.S Tomlin (Ed.), The Pesticide Manual, 14th ed., 2006, BCPC Alton, Hampshire, UK, p. 1047). Topramezone is known to be an inhibitor of 4-hydroxyphenylpyruvatdioxygenase (4-HPPD inhibitor) and provides highly effective control of annual warm season grasses such as Echinochloa-, Setaria-, Digitaria- and Panicum-species, and of dicotyledonous weeds, like Chenopodium-, Atriplex-, Amaranthus-, Solanum-, Galinsoga- Stellaria media, Lamium-, and Veronica-species (see e.g. A. Schönhammer et al. Zeitschrift für Pflanzenkrankheiten und Pflanzenschutz).

Bromoxynil (IUPAC: 3,5-Dibromo-4-hydroxybenzonitrile or 3,5-Dibromo-4-hydroxyphenyl cyanide) as well as its salts and esters, is also a well-known herbicide active compound (see C.D.S Tomlin (Ed.), The Pesticide Manual, 14th ed., 2006, BCPC Alton, Hampshire, UK, p. 118). Bromoxynil works by inhibiting photosynthetic electron transport at photosystem II receptor site of a plant (PS II inhibitor) and controls of annual broad-leaved weeds such as Polygonum, Solanum, Abutilon theophrasti, Amaranthus, Ambrosia artemisiifolia L., Xanthium, Pluchea camphorata, and Sinapis arvensis L. species (see e.g. Bromoxynil, Pesticide Info of Ministry of Agriculture, Food and Fisheries of British Columbia).

WO 99/65314 teaches that co-application of certain 4-benzoyl substituted 5-hydroxypyrazole compounds including topramezone with certain other herbicides including bromoxynil may lead to a synergistic herbicidal activity.

WO 2004/080172 teaches to combine 4-benzoyl substituted 5-hydroxypyrazole compounds including topramezone with a safening amount of cloquintocet or its environmentally acceptable salts, esters, amides or hydrates and optionally with other herbicides including bromoxynil.

It is an object of the present invention to provide herbicidal compositions comprising topramezone, bromoxynil and a safener that show enhanced herbicidal activity against unwanted plants and/or improved compatibility with crop plants, in particular with cereal crops such as, for example, corn, wheat, rice, oats, durum, triticale, rye, flax and barley. Preferably, the composition should have enhanced post-emergence herbicidal activity against unwanted plants. In addition, the compositions according to the invention should have a broad spectrum of activity.

A further object of the present invention is reducing the application rates of active ingredients.

Another object of the present invention is to provide a herbicidal composition comprising topramezone, bromoxynil and a safener that exhibit good physical and chemical stability.

This and further objects are achieved by an emulsifiable concentrate (EC) according to the present invention comprising
A) topramezone or an agriculturally acceptable salt or ester thereof,
B) bromoxynil or an agriculturally acceptable salt or ester thereof,
C) at least one herbicide safener,
D) at least one emulsifier and
E) a solvent system comprising
   e1) dimethylsulfoxide and
   e2) at least one organic solvent different from e1).

Surprisingly, the ECs according to the present invention demonstrate a better herbicidal activity against unwanted plants than would have been expected by the herbicidal activity of the individual compounds or mixtures thereof. In other words, the joint herbicidal activity of the mixture of topramezone, bromoxynil and a safener is further increased when said mixture is formulated according to the present invention.

The present invention entails a series of additional advantages. Particularly, the ECs of the invention show very good herbicidal activity against a broad spectrum of weeds that have high economic impact. Further, ECs of the present invention demonstrate very good compatibility with useful plants, i.e. their use in crops does not result in increased damage when compared to the application of the individual components or mixtures thereof. Further, the ECs according to the invention, although containing large amounts of active ingredients, exhibit good physical and chemical stability upon storage, in particular over prolonged storage times, especially at elevated temperatures. Upon dilution with water the ECs give stable aqueous emulsions that have very good herbicidal activity.

Therefore, the present invention also provides ready to use herbicidal formulations obtainable by diluting ECs according to the present invention with water.

The use of both, the ECs and/or the ready to use herbicidal formulations for controlling undesired vegetation falls within this invention.

Further, the invention provides a process for preparation of an EC according to the present invention, comprising the steps of mixing individual components A), B), C), D), and E) according to the definition given herein, if appropriate with agitation and/or heating.

Further, the invention provides a method for controlling undesirable vegetation, which method comprises allowing the EC according to the present invention to act on plants, their habitat and/or their seeds.

Further embodiments of the present invention are evident from the claims, the description and the examples. It is to be understood that the features mentioned above and still to be illustrated below of the subject matter of the invention can be applied not only in the combination given in each particular case but also in other combinations, without leaving the scope of the invention.

As used herein, the term “safeners” means organic active compounds, some of which may also have herbicidal activity, which reduce or even prevent damage to the crop plants by herbicides.

As used herein, the term “agriculturally acceptable salts” means the salts of those cations and the acid addition salts of those acids whose cations and anions, respectively, have no adverse effect on the herbicidal activity of an active ingredient.

Preferred cations are the ions of the alkali metals, preferably of lithium, sodium and potassium, of the alkali earth metals, preferably of calcium and magnesium, and of the transition metals, preferably of manganese, copper, zinc and iron, further ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, heptylammonium, dodecylammonium, tetradecylammonium, tetramethylammonium, tetraethylammonium, tetrabutylammonium, 2 hydroxyethyl-ammonium (olamine salt), 2-(2-hydroxyeth-1-oxy)eth-1-ylammonium (diglycolamine salt), di(2-hydroxyeth-1-yl)-ammonium (diolamine salt), tris(2-hydroxyethyl)ammonium (trolamine salt), tris(2-hydroxy-propyl)ammonium, benzyltrimethylammonium, benzyltriethylammonium, N,N,N-trimethylethanol-ammonium (choline salt), furthermore phosphonium ions, sulfonium ions, preferably tri(C₁-C₄-alkyl)sulfonium, such as trimethylsulfonium, and sulfoxonium ions, preferably tri(C₁-C₄-alkyl)sulfoxonium, and finally the salts of polybasic amines such as N,N-bis-(3-amino-propyl)methylamine and diethylenetriamine.

Anions of useful acid addition salts are primarily chloride, bromide, fluoride, iodide, hydrogensulfate, methylsulfate, sulfate, dihydrogenphosphate, hydrogenphosphate, nitrate, bicarbonate, carbonate, hexafluorosilicate, hexafluorophosphate, benzoate and also the anions of C₁-C₄-alkanoic acids, preferably formate, acetate, propionate and butyrate.

As used herein, the term “agriculturally acceptable esters” means, for example, allyl esters, propargyl esters, C₁-C₁₀-alkyl esters, alkoxyalkyl esters, tefuryl ((tetrahydrofuran-2-yl)methyl) esters. Preferred alkyl esters are, for example, the methyl, ethyl, propyl, isopropyl, butyl, isobutyl, pentyl, mexyl (1-methylhexyl), methyl (1-methylheptyl), heptyl, octyl or isooctyl (2-ethylhexyl) esters. Preferred C₁-C₄-alkoxy-C₁-C₄-alkyl esters are the straight-chain or branched C₁-C₄-alkoxy ethyl esters, for example the 2-methoxyethyl, 2-ethoxyethyl, 2-butoxyethyl (butotyl), 2-butoxypropyl or 3-butoxypropyl ester.

Preferable salts and esters of bromoxynil are, for example, bromoxynil-butyrate, bromoxynil-heptanoate, bromoxynil-octanoate, bromoxynil-potassium and bromoxynil-sodium.

Preferable salt of topramezone is, for example, topramezone-sodium.

In one embodiment, the EC of the present invention contains
A) 0.25 to 30%, preferably 0.5 to 20%, more preferably 0.5 to 15%, and most preferably 1 to 10% by weight, based on the total weight of the EC of topramezone or an agriculturally acceptable salt or ester thereof,
B) 1.5 to 40%, preferably 3.5 to 37%, more preferably 5 to 35%, and most preferably 10 to 30% by weight, based on the total weight of the EC of bromoxynil or an agriculturally acceptable salt or ester thereof,
C) 0.25 to 30%, preferably 0.5 to 20%, more preferably 0.5 to 15%, and most preferably 1 to 10% by weight, based on the total weight of the EC of at least one herbicide safener,
D) 1 to 35%, preferably 1.5 to 30%, more preferably 2 to 25%, and most preferably 5 to 20% by weight, based on the total weight of the EC of at least one emulsifier and
E) 4 to 97%, preferably 5 to 94%, more preferably 6 to 92%, and most preferably 10 to 83% by weight, based on the total weight of the EC of a solvent system comprising
   e1) dimethylsulfoxide and
   e2) at least one organic solvent different from e1).

The total amount of the components A) and B) will, as a rule, not exceed 60%, preferably 55%, more preferably 50%, and most preferably 40% by weight, based on the total weight of the EC according to the invention and is typically in the range from 5 to 60%, preferably in the range from 5 to 55%, more preferably in the range of from 10 to 50%, most preferably in the range of from 15 to 40% by weight based on the total weight of the EC according to the invention.

The weight ratio between components A) and B) in the EC of the present invention is, as a rule, in the range from 20:1 to 1:40, preferably in the range from 6:1 to 1:35, more preferably in the range of from 3:1 to 1:30 and most preferably in the range from 1:1 to 1:25.

In one embodiment, the EC of the present invention contains 25 to 35%, preferably 20 to 30%, more preferably 15 to 25%, and most preferably 10 to 20% by weight, based on the total weight of the EC of dimethylsulfoxide e1).

The weight ratio between components A) and e1) in the EC of the present invention is, as a rule, in the range from 2:1 to 1:30, preferably in the range from 1:1 to 1:25, more preferably in the range of from 1:2 to 1:20 and most preferably in the range from 1:4 to 1:15.

In another embodiment, the weight ratio between components D) and e1) in the EC of the present invention is, as a rule, in the range from 8:1 to 1:8, preferably in the range from 6:1 to 1:6, more preferably in the range of from 4:1 to 1:4 and most preferably in the range from 2:1 to 1:2.

The ECs according to the present invention comprise at least one safener C). Examples of preferred safeners C) are benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4,5]decane (MON4660, CAS 71526-07-3), 2,2,5-trimethyl-3-(dichloroacetyl)-1,3-oxazolidine (R-29148, CAS 52836-31-4) and N-(2-Methoxybenzoyl)-4-[(methylaminocarbonyl)amino]benzenesulfonamide (CAS 129531-12-0).

More preferred safeners C) are benoxacor, cloquintocet, cyprosulfamide, dichlormid, fenchlorazole, fenclorim, furilazole, isoxadifen, mefenpyr, naphtalic anhydride, 4-(dichloroacetyl)-1-oxa-4-azaspiro[4,5]decane (MON4660, CAS 71526-07-3), 2,2,5-trimethyl-3-(dichloroacetyl)-1,3-oxazolidine (R-29148, CAS 52836-31-4) and N-(2-Methoxybenzoyl)-4-[(methylaminocarbonyl)amino]benzenesulfonamide (CAS 129531-12-0).

Most preferred safener C) is cloquintocet, in particular cloquintocet-mexyl.

The safeners C) are known herbicides and safeners, see, for example, The Compendium of Pesticide Common Names (http://www.alanwood.net/pesticides/); Farm Chemicals Handbook 2000 volume 86, Meister Publishing Company, 2000; B. Hock, C. Fedtke, R. R. Schmidt, Herbizide [Herbicides], Georg Thieme Verlag, Stuttgart 1995; W. H. Ahrens, Herbicide Handbook, 7th edition, Weed Science Society of America, 1994; and K. K. Hatzios, Herbicide Handbook, Supplement for the 7th edition, Weed Science Society of America, 1998. 2,2,5-Trimethyl-3-(dichloroacetyl)-1,3-oxazolidine [CAS No. 52836-31-4] is also referred to as R-29148. 4-(Dichloroacetyl)-1-oxa-4-azaspiro[4,5]decane [CAS No. 71526-07-3] is also referred to as AD-67 and MON 4660.

Safeners C) having a carboxyl group can be employed in the form of the acid, in the form of an agriculturally acceptable salt as mentioned herein, or in the form of an agriculturally acceptable ester, thioester or amide in the ECs according to the invention.

Examples of suitable amides are mono- and di-C₁-C₆-alkylamides or arylamides, examples of suitable esters are allyl esters, propargyl esters, C₁-C₁₀-alkyl esters, alkoxyalkyl esters, tefuryl ((tetrahydrofuran-2-yl)methyl) esters, examples of suitable thioesters are C₁-C₁₀-alkylthio esters. Preferred mono- and di-C₁-C₆-alkylamides are the methyl and the dimethylamides. Preferred arylamides are, for example, the anilides and the 2-chloroanilides. Preferred alkyl esters are, for example, the methyl, ethyl, propyl, isopropyl, butyl, isobutyl, pentyl, mexyl (1-methylhexyl), meptyl (1-methylheptyl), heptyl, octyl or isooctyl (2-ethylhexyl) esters. Preferred C₁-C₄-alkoxy-C₁-C₄-alkyl esters are the straight-chain or branched C₁-C₄-alkoxy ethyl esters, for example the 2-methoxyethyl, 2-ethoxyethyl, 2-butoxyethyl (butotyl), 2-butoxypropyl or 3-butoxypropyl ester. An example of a straight-chain or branched C₁-C₁₀-alkylthio ester is the ethylthio ester.

The ECs of the present invention also contain at least one emulsifier as component D). The emulsifier serves to reduce surface tension between the continuous and the disperse phase, thereby stabilizing the droplets of the disperse phase. Suitable emulsifiers are well known in the art, e.g. from McCutcheon's Detergents and Emulsifiers, Int. Ed., Ridgewood, N.Y. Suitable emulsifiers comprised in the ECs of the present invention include non-ionic, anionic, cationic and zwitterionic surfactants and mixtures thereof. The surfactants may be polymeric or non-polymeric. Non-polymeric surfactants, in contrast to polymeric surfactants, will generally have a molecular weight of below 2000 (number average), preferably from 150 to 2000, more preferably from 200 to 1500.

It is preferred to use at least two, more preferably two to five emulsifiers, preferably with different HLB values. The HLB (Hydrophile-lipophile-Balance) is an empirical scale defined by W. C. Griffin (J. Soc. Cosmetic Chemists, 1, 311 (1949)) which expresses the amphiphilic nature of emulsifying agents (particularly non-ionic emulsifiers). The least hydrophilic emulsifiers are assigned the lowest HLB values.

Suitable cationic emulsifiers D) are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable non-ionic emulsifiers D) are, for example, such non-ioninc surfactants as alkoxylated fats or oils of animal or vegetable origin such as maize oil ethoxylates, castor oil ethoxylates, tallow fat ethoxylates, glycerol esters such as glycerol monostearate, fatty alcohol alkoxylates and oxoalcohol alkoxylates, fatty acid alkoxylates such as oleic acid ethoxylate, alkylphenyl alkoxylates such as isononyl-, isooctyl-, tributyl- and tristearylphenyl ethoxylates, fatty amine alkoxylates, fatty acid amide alkoxylates, sugar emulsifiers such as sorbitan fatty acid esters (sorbitan monooleate, sorbitan tristearate), polyoxyethylene sorbitan fatty acid esters, alkylpolyglycosides, N-alkylgluconamides, alkylmethyl sulfoxides, alkyldimethylphosphine oxides such as tetradecyldimethylphosphine oxide, ethylene oxide/propylene oxide copolymers and mixtures of such non-ionic emulsifiers.

Preferred non-ionic emulsifiers D) include in particular the following non-ionic surfactants:
poly(C₂-C₄)alkoxylates of C₃-C₂₂-alkanols, in particular polyethoxylates and polyethoxylates-co-propoxylates of linear or branched C₃-C₂₂-alkanols, more preferably polyethoxylated C₈-C₂₂-fatty alcohols and polyethoxylated C₃-C₂₀-oxoalcohols, such as polyethoxylated decanol, polyethoxylated lauryl alcohol, polyethoxylated isotridecanol, polyethoxylated cetyl alcohol, polyethoxylated stearyl alcohol poly-ethoxylates-co-propoxylates of octanol, poly-ethoxylates-co-propoxylates of 2-ethyl-hexanol, poly-ethoxylates-co-propoxylates of nonanol, poly-ethoxylates-co-propoxylates of 3-propyl-heptanol, poly-ethoxylates-co-propoxylates of 2-ethyl-octanol, poly-ethoxylates-co-propoxylates of butanol, poly-ethoxylates-co-propoxylates of iso-butanol, and poly-ethoxylates-co-propoxylates of decanol, and esters thereof, such as acetates;
poly(C₂-C₄)alkoxylates of arylalcohols and poly(C₂-C₄)alkoxylates of C₁-C₁₆-alkylaryl alkohols, such as polyoxy-C₂-C₃-alkylene C₈-C₂₂-alkylbenzene ethers, in particular polyethoxylates of C₁-C₁₆-alkylphenols, such as polyethoxylates of nonylphenol, decylphenol, isodecylphenol, dodecylphenol or isotridecylphenol,
poly(C₂-C₄)alkoxylates of mono-, di- or tristyryl phenols, in particular polyethoxylates of mono-, di- and tristyrylphenols; and the formaldehyde condensates thereof and the agriculturally acceptable esters thereof, e.g. the acetates;
C₆-C₂₂-alkylglucosides and C₆-C₂₂-alkyl polyglucosides;
polyethoxylates of C₆-C₂₂-alkylglucosides and polyethoxylates of C₆-C₂₂-alkyl polyglucosides;
polyethoxylates of fatty amines, fatty amides or of fatty acid diethanolamides;
polyethoxylates of fatty acids and polyethoxylates of hydroxyl fatty acids;
partial esters of polyols with C₆-C₂₂-alkanoic acids, in particular mono- and diesters of glycerine and mono-, di- and triesters of sorbitan, such as glycerine monostearate, sorbitanmonooleat, sorbitantristearat; and triglyceride polyalkoxylates;
polyethoxylates of partial esters of polyols with C₆-C₂₂-alkanoic acids, in particular polyethoxylates of mono- and diesters of glycerine and polyethoxylates of mono-, di- and triesters of sorbitan, such as polyethoxylates of glycerine monostearate, polyethoxylates of sorbitanmonooleat, polyethoxylates of sorbitanmonostearat and polyethoxylates of sorbitantristearat;
polyethoxylates of vegetable oils, such as soya oil, rapeseed oil, corn oil, sunflower oil, cotton seed oil, linseed oil, coconut oil, palm oil, safflower oil, walnut oil, peanut oil, olive oil or castor oil or animal fats, such as lard, tallow, milkfat, cod liver oil and whale oil; preferred are polyethoxylated vegetable oils; and
acetylene glycols such as 2,4,7,9-tetramethyl-4,7-bis(hydroxy)-5-decyne.

More preferred non-ionic emulsifiers D) are the aforementioned non-ionic surfactants comprising polyalkoxylate moieties, e.g. polyethoxylates, polypropoxylates and polyethoxylates-co-propoxylates.

Most preferred non-ionic emulsifiers D) are non-ionic surfactants selected from poly(C₂-C₄)alkoxylates of mono-, di- or tristyryl phenols, in particular polyethoxylates of mono-, di- and tristyrylphenols; the formaldehyde condensates thereof and/or the agriculturally acceptable esters thereof, e.g. the acetates. Particularly preferred are poly(C₂-C₄)alkoxylates of mono-, di- or tristyryl phenols and agriculturally acceptable esters thereof.

The term poly(C₂-C₄)alkoxylates refers to polyether radicals derived from ethyleneoxide, propyleneoxide or butyleneoxide. The term polyethoxylate refers to a polyether radical derived from ethyleneoxide. Likewise, the term polyoxyethylene-co-polyoxypropylene refers to a polyether radical derived from a mixture of ethyleneoxide and propylenoxide. The number of repeating units in the polyether radicals will generally vary from 4 to 100, in particular from 5 to 50.

Suitable anionic emulsifiers D) are, for example, such anionine surfactants as alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Preferred anionic emulsifiers D) include in particular the sodium, potassium, calcium or ammonium salts of the following anionic surfactants:
C₆-C₂₂-alkylsulfonates such as lauryl sulfonate, isotridecylsulfonate;
C₆-C₂₂-alkylsulfates such as lauryl sulfate, isotridecylsulfate, cetylsulfate and stearylsulfate;
C₁-C₁₆-alkylaryl sulfonates, in particular C₁-C₁₆-alkylbenzene sulfonates, such as cumylsulfonate, octylbenzene sulfonate, nonylbenzene sulfonate, and dodecylbenzene sulfonate; naphthylsulfonate, mono- and di-C₁-C₁₆-alkylnaphthyl sulfonates such as dibutylnaphtylsulfonate;
mono- and di-C₁-C₁₆-alkyldiphenylether (di)sulfonates such as dodecyldiphenylether disulfonate;
sulfates and sulfonates of fatty acids and fatty acid esters;
sulfates of poly(C₂-C₄)alkoxylated C₃-C₂₂-alkanols, in particular sulfates of ethoxylated C₃-C₂₂-alkanols such as sulfates of ethoxylated lauryl alcohol;
sulfates of poly(C₂-C₄)alkoxylated C₁-C₁₆-alkylphenols, in particular sulfates of ethoxylated C₁-C₁₆-alkylphenols;
di-C₄-C₁₈-alkylesters of sulfosuccinic acid (=C₄-C₁₈-dialkyl sulfosuccinates) such as dioctylsulfosuccinate;
condensates of naphthalinesulfonic acid, C₁-C₁₆-alkyl naphthalinesulfonic acid or phenolsulfonic acid with formaldehyde (=(C₁-C₁₆-alkyl) naphthalene sulfonate-formaldehyde condensates and phenolsulfonate formaldehyde condensates);
sulfates of poly(C₂-C₄)alkoxylated mono- di- or tristyryl phenols, in particular polyethoxylates of mono-, di- or tristyrylphenol;
mono- and di-C₃-C₂₂-alkyl sulfates;
phosphates of poly(C₂-C₄)alkoxylated C₃-C₂₂-alkanols;
phosphates of poly(C₂-C₄)alkoxylated C₁-C₁₆-alkylphenols;
poly(C₂-C₄)alkoxylates mono- di- or tristyryl phenyl etherphosphates;
polyoxyethylene polycarboxylates, in particular homo- and copolymers of monoethylenically unsaturated mono- or dicarboxylic acids having from 3 to 8 carbon atoms,
the copolymers also having polyethylene oxide side chains;
salts of fatty acids such as stearates; and
polyphosphates such as hexametaphosphates and triphosphates (=tripolyphosphate).

More preferred anionic emulsifiers D) are aforementioned anionic surfactants having a sulfonate group or a sulfate group, in particular those having a sulfonate group.

Most preferred anionic emulsifiers D) are anionic surfactants selected from C₁-C₁₆-alkylaryl sulfonates, such as C₁-C₁₆-alkylbenzene sulfonates, e.g. cumylsulfonate, octylbenzene sulfonate, nonylbenzene sulfonate, and dodecylbenzene sulfonate; naphthylsulfonate, mono- and di-C₁-C₁₆-alkylnaphthyl sulfonates such as dibutylnaphtylsulfonate. Particularly preferred are C₁-C₁₆-alkylbenzene sulfonates. Examples of such anionic surfactants are dibutylnaphtalene sulfonate, dodecyldiphenylether sulfonate, cumyl sulfonate, octylbenzene sulfonate, nonylbenzene sulfonate, dodecylbenzene sulfonate and tridecylbenzene sulfonate.

The ECs according to the invention preferably contain emulsifiers D) selected from non-ionic and anionic surfactants.

According to a preferred embodiment of the invention the ECs comprise at least two, preferably two emulsifiers D).

According to a more preferred embodiment of the invention the ECs comprise at least one non-ionic emulsifier D) and at least one anionic emulsifier D).

The ECs of the present invention also contain at least one organic solvent as component e2). Solvents e2) of the ECs according to the present invention are preferably chosen from aliphatic hydrocarbon solvents and aromatic hydrocarbon solvents, which all have boiling points of at least 100° C. and preferably boiling points in the range of from 170 to 310° C. (as general reference for hydrocarbons see, for example, Römpp Lexikon Chemie, 10th edition, volume 3, page 2202 (1997), Georg Thieme Verlag Stuttgart/New York).

In this context aliphatic hydrocarbon solvents with a boiling point of at least 100° C. particularly refer to saturated and unsaturated hydrocarbons that may optionally include a non-aromatic carbocycle, such as linear, branched and cyclic alkanes and alkenes, that have boiling points in the stated range and include 7 to about 18 carbon atoms, and in particular also to mixtures of these aliphatic hydrocarbons. Such mixtures are commercially available e.g. under the trade name Exxsol which denotes products that predominantly contain kerosene having been depleted of aromatic components, such as Exxsol™ D30, Exxsol™ D40, Exxsol™ D80, Exxsol™ D100, Exxsol™ D120 and Exxsol™ D220/230. An example of an aliphatic hydrocarbon having a carbocycle is limonene.

In the context of the invention aromatic hydrocarbon solvents with a boiling point of at least 100° C., preferably in a range from 100° C. to 400° C. particularly refer to mono- or polycyclic aromatic compounds which optionally may carry one or more aliphatic or araliphatic substituents, in particular alkyl and arylalkyl moieties, and which have boiling points in the stated range. Said aromatic hydrocarbon solvents preferably refer to mixtures of such aromatic compounds that are obtained by distillation in particular from crude oil products as fractions in the given boiling point range, such as the commercial products known under the trade names Solvesso®, Aromatic®, Hydrosol®, Caromax®, Aromat® etc.

Particularly preferred solvents e2) are the aromatic hydrocarbon solvents mentioned above.

The aforelisted components D) and E) are known to the skilled person. An overview can be found, for example, in McCutcheon's “Detergents and Emulsifiers Annual”, MC Publ. Corp., Ridgewood N.J.; Sisley and Wood, “Encyclopedia of Surface active Agents”, Chem. Publ. Co. Inc, N.Y. 1964; Schönfeldt, “Grenzflächenaktive Äthylenoxidaddukte” [Interface-active ethylene oxide adducts], Wiss. Verlagsgesellschaft, Stuttgart 1976; Winnacker-Küchler, “Chemische Technologie” [Chemical technology], volume 7, C. Hauser-Verlag, Munich, 4th edition 1986.

To widen the spectrum of action and to obtain synergistic effects, the ECs of the invention can be mixed with a large number of further herbicidal or growth-regulatory active substances (component F or herbicide F) or applied together with these.

Examples of herbicides F), which are suitable for ECs according to the present invention, are
f1) from the group of the lipid biosynthesis inhibitors:

ACC-herbicides such as alloxydim, butroxydim, clethodim, clodinafop, cycloxydim, cyhalofop, diclofop, fenoxaprop, fenoxaprop-P, fluazifop, fluazifop-P, haloxyfop, haloxyfop-P, metamifop, pinoxaden, profoxydim, propaquizafop, quizalofop, quizalofop-P, sethoxydim, tepraloxydim, tralkoxydim,

and non ACC herbicides such as benfuresate, butylate, cycloate, dalapon, dimepiperate, EPTC, esprocarb, ethofumesate, flupropanate, molinate, orbencarb, pebulate, prosulfocarb, TCA, thiobencarb, tiocarbazil, triallate and vernolate;
f2) from the group of the ALS inhibitors:

sulfonylureas such as amidosulfuron, azimsulfuron, bensulfuron, chlorimuron, chlorsulfuron, cinosulfuron, cyclosulfamuron, ethametsulfuron, ethoxysulfuron, flazasulfuron, flucetosulfuron, flupyrsulfuron, foramsulfuron, halosulfuron, imazosulfuron, iodosulfuron, iofensulfuron, mesosulfuron, metazosulfuron, metsulfuron, nicosulfuron, orthosulfamuron, oxasulfuron, primisulfuron, propyrisulfuron, prosulfuron, pyrazosulfuron, rimsulfuron, sulfometuron, sulfosulfuron, thifensulfuron, triasulfuron, tribenuron, trifloxysulfuron, triflusulfuron, and tritosulfuron,

imidazolinones such as imazamethabenz, imazamox, imazapic, imazapyr, imazaquin and imazethapyr,

triazolopyrimidine herbicides and sulfonanilides such as cloransulam, diclosulam, flumetsulam, florasulam, metosulam, penoxsulam, pyrimisulfan and pyroxsulam,

pyrimidinylbenzoates such as bispyribac, pyribenzoxim, pyriftalid, pyriminobac, pyrithiobac, sulfonylaminocarbonyl-triazolinone herbicides such as flucarbazone, propoxycarbazone, thiencarbazone and triafamone;
f3) from the group of the photosynthesis inhibitors:

amicarbazone, inhibitors of the photosystem II, e.g. triazine herbicides, including of chlorotriazine, triazinones, triazindiones, methylthiotriazines and pyridazinones such as ametryn, atrazine, chloridazone, cyanazine, desmetryn, dimethametryn, hexazinone, metribuzin, prometon, prometryn, propazine, simazine, simetryn, terbumeton, terbuthylazin, terbutryn and trietazin, aryl urea such as chlorobromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron and thiadiazuron, phenyl carbamates such as desmedipham, karbutilat, phenmedipham, nitrile herbicides such as bromofenoxim, ioxynil, uraciles such as bromacil, lenacil and terbacil, and bentazon, pyridate, pyridafol, pentanochlor and propanil and inhibitors of the photosystem I such as diquat and paraquat.
f4) from the group of the protoporphyrinogen-IX oxidase inhibitors:

acifluorfen, azafenidin, bencarbazone, benzfendizone, bifenox, butafenacil, carfentrazone, chlomethoxyfen, fluazolate, flufenpyr, flumiclorac, flumioxazin, fluoroglycofen, fluthiacet, fomesafen, halosafen, lactofen, oxadiargyl, oxadiazon, oxyfluorfen, pentoxazone, profluazol, pyraclonil, pyraflufen, saflufenacil, sulfentrazone, thidiazimin and tiafenacil;
f5) from the group of the bleacher herbicides:

PDS inhibitors: beflubutamid, diflufenican, fluridone, flurochloridone, flurtamone, norflurazon, picolinafen,

HPPD inhibitors: benzobicyclon, benzofenap, clomazone, fenquintrione, isoxaflutole, mesotrione, pyrasulfotole, pyrazolynate, pyrazoxyfen, sulcotrione, tefuryltrione, tembotrione, and bicyclopyrone, bleacher, unknown target: aclonifen, amitrole and flumeturon;
f6) from the group of the EPSP synthase inhibitors: glyphosate;
f7) from the group of the glutamine synthase inhibitors: bilanaphos (bialaphos), glufosinate and glufosinate-P;
f8) from the group of the DHP synthase inhibitors: asulam;
f9) from the group of the mitosis inhibitors:

compounds of group K1: dinitroanilines such as benfluralin, butralin, dinitramine, ethalfluralin, fluchloralin, oryzalin, pendimethalin, prodiamine and trifluralin, phosphoramidates such as amiprophos, and butamiphos, benzoic acid herbicides such as chlorthal, pyridines such as dithiopyr and thiazopyr, benzamides such as propyzamide and tebutam; compounds of group K2: chlorpropham, propham and carbetamide;
f10) from the group of the VLCFA inhibitors:

chloroacetamides such as acetochlor, alachlor, butachlor, dimethachlor, dimethenamid, dimethenamid-P, metazachlor, metolachlor, metolachlor-S, pethoxamid, pretilachlor, propachlor, propisochlor and thenylchlor, oxyacetanilides such as flufenacet and mefenacet, acetanilides such as diphenamid, naproanilide, napropamide and napropamide-M, tetrazolinones such fentrazamide, and other herbicides such as anilofos, cafenstrole, fenoxasulfone, ipfencarbazone, piperophos and pyroxasulfone;
f11) from the group of the cellulose biosynthesis inhibitors: chlorthiamid, dichlobenil, flupoxam and isoxaben;
f12) from the group of the decoupler herbicides: dinoseb, dinoterb and DNOC;
f13) from the group of the auxinic herbicides:

2,4-D, 2,4-DB, aminocyclopyrachlor, aminopyralid, benazolin, chloramben, clomeprop, clopyralid, dicamba, dichlorprop, dichlorprop-P, fluroxypyr, halauxifen; MCPA, MCPB, mecoprop, mecoprop-P, picloram, quinclorac, quinmerac, TBA (2,3,6) and triclopyr;
f14) from the group of the auxin transport inhibitors: diflufenzopyr and naptalam;
f15) from the group of the other herbicides: bromobutide, chlorflurenol, cinmethylin, cumyluron, cyclopyrimorate, dalapon, dazomet, difenzoquat, dimethipin, DSMA, dymron, endothal, etobenzanid, flamprop, flamprop-M, flurenol, flurprimidol, fosamine, indanofan, indaziflam, maleic hydrazide, mefluidide, metam, methiozolin (CAS 403640-27-7), methyl azide, methyl bromide, methyl-dymron, methyl iodide, MSMA, oleic acid, oxaziclomefone, pelargonic acid, pyributicarb, quinoclamine, triaziflam, tridiphane, tribenuron, trifloxysulfuron, triflusulfuron and tritosulfuron;
   including agriculturally acceptable salts, esters and/or thioesters thereof.

The herbicides F) are known herbicides, see, for example, The Compendium of Pesticide Common Names (http://www.alanwood.net/pesticides/).

The ECs according to the invention may also comprise customary adjuvants, such as viscosity-modifying additives (thickeners), anti-foaming agents, anti-freezing agents, bactericides, preservatives, colorants, perfumes, anti-drift agents, adhesives, penetrants (penetration enhancers), antioxidants etc., which are usually employed in aqueous formulations of herbicides. The amount of adjuvants will generally not exceed 30% by weight, in particular 25% by weight of the total weight of the SC.

Suitable thickeners are compounds which affect the rheological properties of aqueous SCs, even when used in small amounts. These include in particular all substances which increase the viscosity of aqueous preparations, specifically those which are suitable for plant protection formulations.

Examples of suitable thickeners are natural silicates and modified natural silicates, such as chemically modified bentonites, hectorites, attapulgites, montmorillonites, smectites; silicate minerals, such as Bentone® (Elementis), Attagel® (Engelhard), Agsorb® (Oil-Dri Corporation) or Hectorite® (Akzo Nobel), and thickeners based on synthetic polymers, for example polyalkyl(meth)acrylates, polyamide thickeners, polyurethane thickeners, xanthan gum, for example the products sold under the name Rhodopol® (Rhodia) and Kelzan® S (Kelco Corp.). Preferred thickeners are silicate minerals and thickeners based on synthetic polymers.

Suitable anti-foaming agents are silicone emulsions (such as, for example, Silikon® SRE, Wacker, Germany, or Rhodorsil®, Rhodia, France), long-chain alcohols, fatty acids, salts of fatty acids, organofluorine compounds and their mixtures. Preferred are anti-foaming agents based on silicones.

Suitable anti-freezing agents are those from the group of the ureas, diols and polyols, such as ethylene glycol and propylene glycol.

Suitable bactericides are those based on dichlorophene and benzyl alcohol hemiformal (Proxel® from ICI or Acticide® RS from Thor Chemie and Kathon® MK from Rohm & Haas) and also isothiazolinone derivatives such as alkylisothiazolinones and benzisothiazolinones (Acticide® MBS from Thor Chemie).

Suitable preservatives, colorants and perfumes are known to the skilled worker, for example from the literature mentioned above in connection with surfactants, and from Watkins, “Handbook of Insecticide Dust Diluents and Carriers”, 2nd Ed., Darland Books, Caldwell N.J.; H. v. Olphen, “Introduction to Clay Colloid Chemistry”; 2nd Ed., J. Wiley & Sons, N.Y.; and C. Marsden, “Solvents Guide”; 2nd Ed., Interscience, N.Y. 1963.

The ECs according to the invention can be prepared by methods known per se for the preparation of concentrates, for example by mixing components. Such methods are described, for instance by Mollet and Grubemann, Formulation technology, Wiley VCH, Weinheim, 2001; or Knowles, New develop-ments in crop protection product formulation, Agrow Reports DS243, T&F Informa, London, 2005.

Customary agitating (e.g. mixing) devices which, if appropriate, can be heated may be used for preparing the mixtures.

The invention also relates to uses of the ECs of the invention for protecting crop plants and to methods of controlling undesired vegetation, which comprise applying the ECs, in diluted or undiluted form, to plants, their environment and/or seeds.

The herbicidal SCs of the invention affect a very good control of vegetation in non-crop areas, especially at high application rates. In crops such as soybean, cotton, oilseed rape, flax, lentils, rice, sugar beet, sunflower, tobacco and cereals, such as, for example maize or wheat, they are active against broad-leaved weeds and grass weeds without inflicting substantial damage to the crop plants. This effect is particularly observed at low application rates.

Depending on the application method in question, the ECs of the invention can additionally be employed in a further number of crop plants to remove undesired plants. Suitable crops are, for example, the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera and Zea mays.

In addition, the ECs of the invention can also be used in crops which tolerate the effect of herbicides as the result of breeding, including genetic engineering methods.

Furthermore, the ECs of the invention can also be used in crops which tolerate attack by insects or fungi as the result of breeding, including genetic engineering methods.

In general, the ECs described herein are useful for controlling undesired vegetation. For this purpose, the ECs may be applied as such or are preferably applied after dilution with water. Preferably, for various purposes of end user application, a so-called aqueous spray-liquor is prepared by diluting the EC of the present invention with water, e.g. tap water. The spray-liquors may also comprise further constituents in dissolved, emulsified or suspended form, for example fertilizers, active substances of other groups of herbicidal or growth-regulatory active substances, further active substances, for example active substances for controlling animal pests or phytopathogenic fungi or bacteria, furthermore mineral salts which are employed for alleviating nutritional and trace element deficiencies, and non-phytotoxic oils or oil concentrates. As a rule, these constituents are added to the spray mixture before, during or after dilution of the ECs according to the invention.

The ECs of the invention can be applied by the pre-emergence or the post-emergence method. If any of components of the ECs to the present invention is less well tolerated by certain crop plants, application techniques may be employed where the ECs are sprayed, with the aid of the spraying apparatus, in such a way that the leaves of the sensitive crop plants ideally do not come into contact with them, while the active substances reach the leaves of undesired plants which grow underneath, or the bare soil surface (post-directed, lay-by).

Depending on the aim of the control measures, the season, the target plants and the growth stage, the ECs of the invention are applied to such a degree that the application rates of component A) are from 0.001 to 3.0 kg/ha, preferably from 0.01 to 1.0 kg/ha, more preferably from 0.01 to 0.5 kg/ha active ingredient (a.i.) and of component B) are from 0.001 to 3.0 kg/ha, preferably from 0.01 to 1.0 kg/ha, more preferably from 0.01 to 0.5 kg/ha active ingredient (a.i.).

It is of also possible to use the ECs of the present invention as a tank-mix partner with other formulations.

Moreover, it may be useful to apply the ECs of the invention, separately or in combination with other herbicides, jointly as a mixture with yet further plant protection agents, for example with agents for controlling pests or phytopathogenic fungi or bacteria.

The following examples are intended to further illustrate the present invention without limiting its scope in any way.

### PREPARATION EXAMPLES

### I. ECS ACCORDING TO THE INVENTION

Examples EC-1 to EC-4 were prepared by mixing components A), B) and C) all technical grade with components D) and E), where appropriate with heating and agitation until a clear EC has been formed.

TABLE 1
Emulsifiable concentrates according to the present invention

Example:

| | EC 1 | EC 2 | EC 3 | EC 4 |
|---|---|---|---|---|
| Components | g/l | g/l | g/l | g/l |
| A) Topramezone | 12 | 12 | 12 | 12 |
| B) Bromoxynil-octanoate | 240 | 240 | 240 | 240 |
| C) Cloquintocet-mexyl | 12 | 12 | 12 | 12 |
| D) Emulsifier d1) | 75 | 75 | 50 | 50 |
| D) Emulsifier d2) | 75 | 75 | 50 | 50 |
| E) Dimethylsulfoxid e1) | 100 | 150 | 100 | 75 |
| E) Solvent e2) | ad 1 l | ad 1 l | ad 1 l | ad 1 l |

Emuslifier d1): alkyl benzene sulfonate calcium salt;
Emuslifier d2): ethoxylated tristyrylphenol;
Solvent e2): aromatic hydrocarbon.

### II. COMPARATIVE EXAMPLE

A mixture comprising 12 g/l topramezone (CLIO®), 240 g/l bromoxynil-octanoate (BUCTRIL®) and 12 g/l cloquintocet-mexyl (EC in aromatic hydrocarbon) was prepared by mixing together the individual formulations and water.

### III. HERBICIDAL ACTIVITY OF THE ECS ACCORDING TO THE INVENTION

The herbicidal activity of the ECs according to the present invention was demonstrated by the following post-emergence greenhouse experiments:

The culture containers were plastic flower pots containing loamy sand with approximately 3.0% of humus as the substrate.

The test plants were first grown to a height of 3 to 15 cm depending on the plant habit and only then treated with the active compounds suspended in water. They were either grown directly in the test containers or transplanted as seedlings into the test containers a few days prior to treatments.

Depending on the species the plants were kept at 10 to 25° C. or 20 to 35° C. The test period extended over two to four weeks. During this time the plants were tended and their response to the individual treatment was evaluated.

Damage by the herbicidal compositions was evaluated with reference to a scale of 0% to 100% in comparison with untreated control plots. 0 means no damage and 100 means complete destruction of the plants.

The plants used in the greenhouse experiments were of the following species:

| Bayer Code | Latin name of the weed |
|---|---|
| AMARE | Amaranthus retroflexus L. |
| CHEAL | Chenopodium album |
| GALAP | Galium aparine |
| KCHSC | Kochia scoparia (L.) Schrad. |
| POLCO | Polygonum convolvulus |

TABLE 2
Post-emergence treatment by the mixture comprising topramezone,
bromoxynil-octanoate and cloquintocet-mexyl (according to the
comparative example) and by the ECs according to the present invention

| | | Treatment, | | | |
|---|---|---|---|---|---|
| | | Damage [%] | | | |
| | Application rate | Comparative | | | |
| Weed | [g ai/ha] | example | EC 1 | EC 2 | EC 4 |
| CHEAL | 33 | 55 | 80 | 85 | 65 |
| KCHSC | 33 | 40 | 80 | 70 | 85 |
| POLCO | 33 | 85 | 100 | 100 | 100 |
| AMARE | 66 | 60 | 100 | 100 | 100 |
| GALAP | 66 | 80 | 100 | 100 | 100 |

The ECs according to the present invention showed better herbicidal activity when compared to the tank mixture of the individual formulations.

1-13. (canceled)

14. An emulsifiable concentrate (EC) comprising
A) topramezone or an agriculturally acceptable salt or ester thereof,
B) bromoxynil or an agriculturally acceptable salt or ester thereof,
C) at least one herbicide safener,
D) at least one emulsifier and
E) a solvent system comprising
e1) dimethylsulfoxide and
e2) at least one organic solvent.

15. The EC according to claim 14 comprising
A) 0.5 to 15% by weight of topramezone or an agriculturally acceptable salt or ester thereof,
B) 5 to 35% by weight of bromoxynil or an agriculturally acceptable salt or ester thereof,
C) 0.5 to 15% by weight of at least one herbicide safener,
D) 2 to 25% by weight of at least one emulsifier and
E) 6 to 92% by weight of the solvent system comprising
e1) dimethylsulfoxide and
e2) at least one organic solvent different from e1).

16. The EC according to claim 14, wherein the herbicide safener C) is selected from benoxacor, cloqintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloracetyl)-1,3-oxazolidine, 4-(dichloroacetyl)-1-oxa-4-azaspiro[4,5]decane, N-(2-methoxybenzoyl)-4-[(methylaminocarbonyl)amino]benzenesulfonamide and oxabetrinil, the salts and agriculturally acceptable derivatives thereof.

17. The EC according to claim 14, wherein the herbicide safener C) is cloquintocet or an agriculturally acceptable salt or ester thereof.

18. The EC according to claim 14, wherein the emulsifier D) is selected from non-ionic surfactants and anionic surfactants.

19. The EC according to claim 14, wherein the emulsifier D) is selected from non-ionic surfactants comprising a polyalkoxylate moiety and anionic surfactants containing a sulfonate group or a sulfate group, or mixtures thereof.

20. The EC according to claim 14, wherein the emulsifier D) is selected from poly(C₂-C₄)alkoxylates of mono, di- or tristyryl phenols or agriculturally acceptable esters thereof, and C₁-C₁₆-alkylated aromatic sulfonic acids or agriculturally acceptable salts thereof.

21. The EC according to claim 14, wherein the emulsifier D) comprises at least two emulsifiers.

22. The EC according to claim 14, wherein the solvent system E) comprises as organic solvent e2) an aromatic hydrocarbon.

23. The EC according to claim 14, additionally comprising at least one further formulation additive.

24. A process for preparation of an EC as defined in claim 14, comprising the steps of mixing components A), B), C), D), and E) according to the definition given in any one of said claims if appropriate with agitation and/or heating.

25. A method for controlling undesired vegetation comprising allowing an EC as defined in claim 14 to act on plants, their habitat and/or their seeds.

26. The method of claim 24, wherein the herbicide safener C) is selected from benoxacor, cloqintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloracetyl)-1,3-oxazolidine, 4-(dichloroacetyl)-1-oxa-4-azaspiro[4,5]decane, N-(2-methoxybenzoyl)-4-[(methylaminocarbonyl)amino]benzenesulfonamide and oxabetrinil, the salts and agriculturally acceptable derivatives thereof.

27. The method of claim 24, wherein the herbicide safener C) is cloquintocet or an agriculturally acceptable salt or ester thereof.

28. The method of claim 24, wherein the emulsifier D) is selected from non-ionic surfactants and anionic surfactants.

29. The method of claim 24, wherein the emulsifier D) is selected from non-ionic surfactants comprising a polyalkoxylate moiety and anionic surfactants containing a sulfonate group or a sulfate group, or mixtures thereof.

30. The method of claim 24, wherein the emulsifier D) is selected from poly(C₂-C₄)alkoxylates of mono, di- or tristyryl phenols or agriculturally acceptable esters thereof, and C₁-C₁₆-alkylated aromatic sulfonic acids or agriculturally acceptable salts thereof.

31. The method of claim 24, wherein the emulsifier D) comprises at least two emulsifiers.

32. The method of claim 24, wherein the solvent system E) comprises as organic solvent e2) an aromatic hydrocarbon.

33. The method of claim 24, wherein the concentrate additionally comprises at least one further formulation additive.
